(19) United States
(12) Patent Application Publication
(10) Pub. No.: US 2006/0023855 A1
(43) Pub. Date: Feb. 2, 2006

(54) Free-call certificate service system

(76) Inventors: Jong-Do Park, Daegu-Si (KR); So-Young Lee, Kyeongsangbuk-Do (KR); Jun-Seog Noh, Daegu-Si (JP); Sang-Hyu Bae, Daegu-Si (KR)

Correspondence Address: CANTOR COLBURN, LLP, 55 GRIFFIN ROAD SOUTH, BLOOMFIELD, CT, 06002, US

(21) Appl. No.: 10/536,787

(22) PCT Filed: Nov. 12, 2003
(86) PCT No.: PCT/KR03/02433

§ 371 Date: May 27, 2005

(30) Foreign Application Priority Data
Nov. 28, 2002 (KR) 10-2002-0074873

(51) Int. Cl. H04M 15/00

(52) U.S. Cl. 379/114.1; 379/114.01

(57) ABSTRACT

Disclosed herein is a free-call certificate service system. The free-call certificate service system is capable of returning a portion of the price for online/offline product purchase or fee for online/offline service use to a customer in the form of a free-call certificate, which allows the customer to conduct a telephone conversation free of charge up to a predetermined amout of money or for a predetermined period of time, as a reward for the product purchase or service use, so as to reduce the customer's burden of communication cost and thus enable the customer to enjoy a more tangible reward service.

### TECHNICAL FIELD

The present invention relates to free-call certificate service systems, and more particularly to a free-call certificate service system which is capable of distributing prepaid free-call certificates to customers to enable the customers to conduct telephone conversations free of charge using the free-call certificates, thereby reducing the customers' burdens of communication costs.

### BACKGROUND ART

There have conventionally been proposed various online/offline reward systems, such as systems for offering mileage points or raffle coupons to customers as rewards for their use of credit cards or their product purchases.

However, the conventional online/offline reward systems are disadvantageous in that a customer cannot immediately enjoy a portion of the price for product purchase or fee for service use, returned thereto as a reward for the product purchase or service use, so he/she cannot immediately perceive such a reward.

For example, provided that a customer is assigned mileage points corresponding to his/her credit card usage fee on a monthly basis, he/she will be able to use the assigned mileage points only when the amount of mileage points saved up to that time becomes greater than or equal to a predetermined value.

Meanwhile, in the case of raffle coupons offered as rewards for product purchases, benefits are distributed to only a small minority of customers drawing winning numbers.

As a result, from the viewpoint of the customers, there is no instant gratification in such conventional reward systems.

This inventor has researched a reward system which is capable of overcoming the limitations of the above-mentioned conventional reward systems to enable customers to directly perceive rewards. As a result of the research, the inventor has developed a free-call certificate-based reward system which is capable of returning a portion of the price for online/offline product purchase or fee for online/offline service use to a customer in the form of a free-call certificate, which allows the customer to conduct a telephone conversation free of charge up to a predetermined amount of money or for a predetermined period of time, as a reward for the product purchase or service use, so as to reduce the customer's burden of communication cost and thus enable the customer to perceive the reward directly. Furthermore, the developed free-call certificate-based reward system can exert advertising effects in various manners. For example, the free-call certificate may be provided in the form of a coupon containing a provider's advertisement. In conclusion, the inventor has developed a reward system using a free-call certificate applicable to all fields of business and industry.

### DISCLOSURE OF THE INVENTION

Therefore, the present invention has been made in view of the above problems, and it is an object of the present invention to provide a free-call certificate service system for returning a portion of the price for online/offline product purchase or fee for online/offline service use to a customer in the form of a free-call certificate, which allows the customer to conduct a telephone conversation free of charge up to a predetermined amount of money or for a predetermined period of time, as a reward for the product purchase or service use, so as to reduce the customer's burden of communication cost and thus enable the customer to enjoy a more tangible reward service.

In accordance with an aspect of the present invention, the above and other objects can be accomplished by the provision of a free-call certificate service system comprising a free-call certificate management server including: a free-call certificate management database for storing information regarding sales of free-call certificates sold to one or more affiliated stores, the free-call certificate sale information containing sub-total free-call times allocated respectively to the affiliated stores within the range of a total free-call time allocated from at least one communication company; a free-call request information receiver for receiving free-call request information containing a telephone number of a customer acquiring a specific one of the free-call certificates and affiliated store identification information from a specific one of one or more affiliated store terminals held respectively by the affiliated stores; an authentication processor for searching the sale information stored in the free-call certificate management database for sale information corresponding to the affiliated store identification information to determine whether the corresponding sale information is present in the stored sale information, and performing an authentication process based on the determination result; and a free-call request information transmitter for transmitting the free-call request information authenticated by the authentication processor to a communication company server managed by the communication company so that the communication company server can deduct the amount of money corresponding to an individual free-call time allocated to the specific free-call certificate acquired by the customer from communication fees to be charged to the customer's telephone number contained in the free-call request information.

Preferably, the free-call certificate management server may further include: a free-call certificate purchase request information transmitter for transmitting free-call certificate purchase request information containing the total free-call time to the communication company server; and a free-call time allocation information receiver for receiving, from the communication company server, free-call time allocation information corresponding to the total free-call time contained in the free-call certificate purchase request information.

The free-call certificate management server may further include: a free-call certificate purchase request information receiver for receiving free-call certificate purchase request information containing each of the sub-total free-call times from each of the affiliated store terminals; and a free-call time allocation information transmitter for transmitting free-call time allocation information corresponding respectively to the sub-total free-call times contained in the free-call certificate purchase request information received by the free-call certificate purchase request information receiver respectively to the affiliated store terminals.

The free-call certificate management server may further include a settlement requester for transmitting settlement request information to at least one financial company server to request it to settle the affiliated stores' accounts for prices for purchases of the free-call certificates, respectively, and then receiving results of settlement from the financial company server.

The free-call certificate management server may further include: a refund request information receiver for receiving refund request information containing a returned amount of a corresponding one of the sub-total free-call times and the affiliated store identification information from the specific affiliated store terminal; and a refund processor for, if the authentication processor searches the sale information stored in the free-call certificate management database for the sale information corresponding to the affiliated store identification information to determine whether the corresponding sale information is present in the stored sale information, and authenticates a specific one of the affiliated stores holding the specific affiliated store terminal as a result of the determination, requesting the financial company server through the settlement requester to pay the specific affiliated store a refund corresponding to the returned free-call time amount contained in the refund request information received by the refund request information receiver, and updating the free-call certificate management database on the basis of the refund request information.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a free-call certificate service system according to a first embodiment of the present invention;

FIG. 2a is a flow chart illustrating the operation of the free-call certificate service system of FIG. 1 in the case where free-call certificates are sold in a resale scheme;

FIG. 2b is a flow chart illustrating the operation of the free-call certificate service system of FIG. 1 in the case where free-call certificates are sold in a cooperative purchase scheme;

FIG. 3 is a block diagram showing the configuration of a free-call certificate service system according to a second embodiment of the present invention;

FIG. 4a is a flow chart illustrating the operation of the free-call certificate service system of FIG. 3 in the case where free-call certificates are sold in a resale scheme; and

FIG. 4b is a flow chart illustrating the operation of the free-call certificate service system of FIG. 3 in the case where free-call certificates are sold in a cooperative purchase scheme.

### BEST MODE FOR CARRYING OUT THE INVENTION

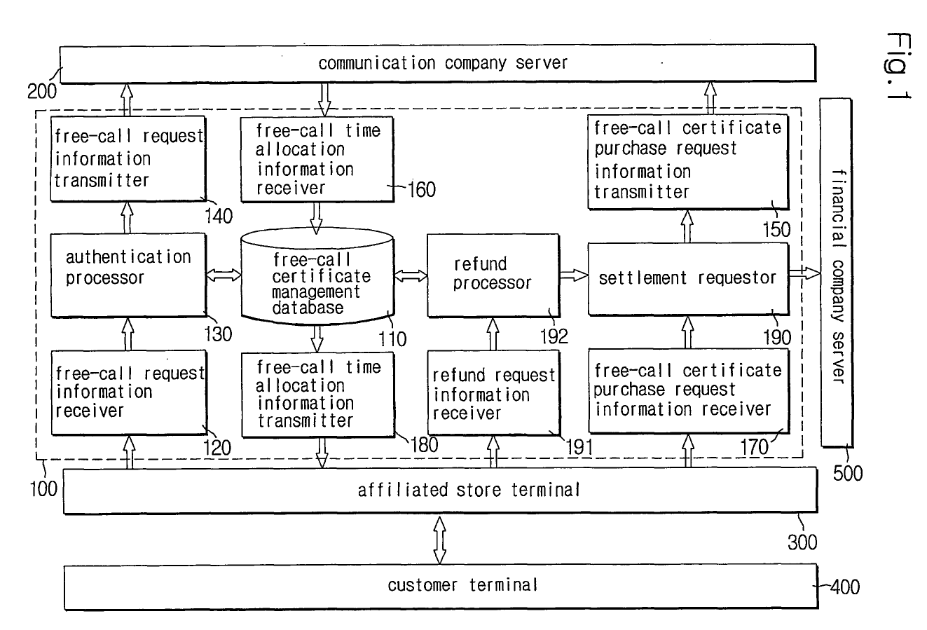

FIG. 1 is a block diagram showing the configuration of a free-call certificate service system according to a first embodiment of the present invention.

In the present embodiment, the free-call certificate service system is adapted to provide free-call certificates to customers through affiliated stores in two schemes, one being a resale scheme wherein a free-call certificate management server purchases free-call certificates from communication companies in large quantities and resells the purchased free-call certificates to the affiliated stores and the stores provide the resold certificates to the customers, and the other being a cooperative purchase scheme wherein the free-call certificate management server collects and sums up the demands for free-call certificates from the affiliated stores, makes a cooperative purchase for the summed-up number of free-call certificates from the communication companies and distributes the purchased free-call certificates to the affiliated stores and the stores provide the distributed certificates to the customers.

The affiliated stores can provide the free-call certificates to customers as rewards for their product purchases or service use, or free of charge to entice the customers for the purpose of gaining future profits therefrom. Therefore, the free-call certificates can be provided online/offline to customers with or without compensation for many purposes throughout society.

The free-call certificates can be provided in various forms such as offline coupons containing a provider's advertisement, or electronic barcodes in digital data format. That is, the free-call certificates can be provided in various ways irrespective of form as long as they have information regarding free calls.

With reference to FIG. 1, the free-call certificate service system according to the first embodiment of the present invention comprises a free-call certificate management server 100, at least one communication company server 200, one or more affiliated store terminals 300, at least one customer terminal 400 and at least one financial company server 500.

The free-call certificate management server 100 acts to purchase free-call certificates from communication companies, sell the purchased free-call certificates to affiliated stores, store information regarding the sales of the purchased certificates and perform a customer relationship management (CRM) process based on the stored free-call certificate sale information.

The free-call certificate management server 100 is adapted to sell free-call certificates in the following two schemes.

The first scheme is a resale scheme wherein the free-call certificate management server purchases free-call certificates from the communication companies in large quantities and resells the purchased free-call certificates to the affiliated stores, and the stores provide the resold certificates to customers.

The second scheme is a cooperative purchase scheme wherein the free-call certificate management server collects and sums up the demands for free-call certificates from the affiliated stores, makes a cooperative purchase for the summed-up number of free-call certificates from the communication companies and distributes the purchased free-call certificates to the affiliated stores, and the stores provide the distributed certificates to customers.

Note that the above-mentioned free-call certificate sale schemes are just matters of sale procedure and have no effect on the configuration of the free-call certificate service system according to the present embodiment.

In detail, the free-call certificate management server 100 includes a free-call certificate management database 110, a free-call request information receiver 120, an authentication processor 130, a free-call request information transmitter 140, a free-call certificate purchase request information transmitter 150, a free-call time allocation information receiver 160, a free-call certificate purchase request information receiver 170, a free-call time allocation information transmitter 180, a settlement requestor 190, a refund request information receiver 191, and a refund processor 192.

The free-call certificate management database 110 is adapted to store information regarding the sales of free-call certificates sold to one or more affiliated stores. The free-call certificate sale information contains sub-total free-call times allocated respectively to the affiliated stores within the range of a total free-call time allocated from at least one communication company.

One or more wired/wireless communication companies provide telephone services to customers, and the customers select the communication companies according to their tastes and receive the telephone services from the selected communication companies.

Therefore, the free-call certificate management server 100 preferably performs an integrated management process of requesting the purchase of free-call certificates from one or more communication companies, receiving free-call times allocated respectively from the communication companies and storing information regarding the sales of free-call certificates sold to respective affiliated stores, which information contains sub-total free-call times allocated respectively to the affiliated stores within the range of a total amount of the free-call times allocated from the communication companies. This integrated management process is well known to those skilled in the art and a detailed description thereof will thus be omitted.

The free-call certificate sale information further contains respective identification information of the affiliated stores, the amount or number of free-call certificates purchased from each communication company by each of the affiliated stores, the amount or number of the purchased free-call certificates in stock, etc. The CRM process can be performed on the basis of the free-call certificate sale information.

The free-call request information receiver 120 is adapted to receive, from a specific one of the affiliated store terminals 300, free-call request information containing a telephone number of a customer acquiring a free-call certificate and affiliated store identification information.

Each affiliated store issues a free-call certificate to a customer as a reward for his/her product purchase or service use and, using a corresponding one of the affiliated store terminals 300, inputs free-call request information with a telephone number of the customer acquiring the free-call certificate to transmit it to the free-call certificate management server 100. At this time, affiliated store identification information, such as a unique number set in the corresponding affiliated store terminal 300, is transmitted to the free-call certificate management server 100 together with the free-call request information.

As an alternative, the free-call request information containing the telephone number of the customer acquiring the free-call certificate may be inputted and transmitted to the free-call certificate management server 100 using the customer terminal 400, not the corresponding affiliated store terminal 300, as will be described later in detail.

Each of the affiliated store terminals 300 may be, for example, a dedicated terminal or personal computer installed in the corresponding affiliated store, or a mobile communication terminal or personal digital assistant (PDA) of the corresponding affiliated store.

The authentication processor 130 is adapted to search the sale information stored in the free-call certificate management database 110 for sale information corresponding to the affiliated store identification information to determine whether the corresponding sale information is present in the stored sale information, and perform an authentication process based on the determination result.

The sale information stored in the free-call certificate management database 110 contains respective identification information of the affiliated stores, the amount or number of free-call certificates purchased from each communication company by each of the affiliated stores, the amount or number of the purchased free-call certificates in stock, etc. The authentication processor 130 searches the stored sale information for the sale information corresponding to the affiliated store identification information transmitted from the specific affiliated store terminal 300, received by the free-call request information receiver 120, to determine whether the corresponding sale information is present in the stored sale information, and performs the authentication process based on the determination result. In the authentication process, the authentication processor 130 outputs authentication information if the corresponding sale information is present in the stored sale information, and authentication failure information if the corresponding sale information is not present in the stored sale information. This technique for searching the database and performing the authentication process based on the search result is well known to those skilled in the art and a detailed description thereof will thus be omitted.

The free-call request information transmitter 140 is adapted to transmit the free-call request information authenticated by the authentication processor 130 to the communication company server 200 so that the server 200 can deduct the amount of money corresponding to an individual free-call time allocated to the free-call certificate acquired by the customer from communication fees to be charged to the customer's telephone number contained in the free-call request information.

In other words, the free-call request information transmitter 140 transmits the free-call request information containing the customer's telephone number, authenticated by the authentication processor 130, to the communication company server 200. A billing server of the communication company server 200 receives the free-call request information transmitted from the free-call request information transmitter 140, deducts the amount of money corresponding to the individual free-call time allocated to the free-call certificate acquired by the customer from communication fees of the next term to be charged to the customer's telephone number contained in the free-call request information, and issues the resulting communication fee bill to the customer. As a result, the customer can enjoy a free-call service using the free-call certificate as a reward for his/her online/offline product purchase or service use. This has the effect of reducing the customer's burden of communication cost, which leads to a more tangible reward.

The free-call certificate purchase request information transmitter 150 is adapted to transmit free-call certificate purchase request information containing a total free-call time to the communication company server 200.

In other words, the free-call certificate management server 100 requests the purchase of free-call certificates with individual free-call times within the range of a total free-call time from at least one communication company online/offline in the resale scheme or cooperative purchase scheme. The offline purchase request can be made based on a contract, and the online purchase request can be made through the fact that the free-call certificate purchase request information transmitter 150 transmits the free-call certificate purchase request information containing the total free-call time to the communication company server 200.

The free-call time allocation information receiver 160 is adapted to receive, from the communication company server 200, free-call time allocation information corresponding to the total free-call time contained in the free-call certificate purchase request information.

That is, if the free-call certificate purchase request information transmitter 150 transmits the free-call certificate purchase request information containing the total free-call time to the communication company server 200, then the server 200 receives the transmitted free-call certificate purchase request information, allocates the total free-call time contained therein to the free-call certificate management server 100 and transmits the resulting allocation information thereto. Then, the free-call time allocation information receiver 160 receives the free-call time allocation information transmitted from the communication company server 200 and stores it in the free-call certificate management database 110.

The free-call certificate purchase request information receiver 170 is adapted to receive free-call certificate purchase request information containing a sub-total free-call time from each of the affiliated store terminals 300.

Each affiliated store desiring to provide free-call certificates to customers requests the purchase of free-call certificates with individual free-call times within the range of a sub-total free-call time corresponding to its demand from the free-call certificate management server 100 online/offline. The offline purchase request can be made based on a contract, and the online purchase request can be made through the fact that each of the affiliated store terminals 300 transmits the free-call certificate purchase request information containing the sub-total free-call time to the free-call certificate purchase request information receiver 170.

The free-call time allocation information transmitter 180 is adapted to transmit free-call time allocation information corresponding respectively to the sub-total free-call times contained in the free-call certificate purchase request information received by the free-call certificate purchase request information receiver 170 respectively to the affiliated store terminals 300.

Upon receiving the free-call certificate purchase request information containing the sub-total free-call time transmitted from each of the affiliated store terminals 300, the free-call certificate management server 100 allocates the corresponding affiliated store the sub-total free-call time within the range of the total free-call time stored in the free-call certificate management database 110 and transmits the resulting allocation information to the corresponding affiliated store terminal 300 to sell free-call certificates with individual free-call times within the range of the sub-total free-call time to the corresponding affiliated store. The free-call certificate management server 100 then stores information regarding the sales of the sold free-call certificates in the free-call certificate management database 110.

The settlement requestor 190 is adapted to transmit settlement request information to the financial company server 500 to request it to settle the affiliated stores' accounts for the prices for purchases of the free-call certificates, respectively, and then receive results of settlement from the financial company server 500.

In other words, upon receiving the free-call certificate purchase request information transmitted from each of the affiliated store terminals 300, the free-call certificate management server 100 transmits a picture associated with settlement of a purchasing price corresponding to the sub-total free-call time contained in the received free-call certificate purchase request information to the corresponding affiliated store terminal 300 to display it thereon. Thereafter, the settlement requester 190 transmits settlement information inputted from the corresponding affiliated store terminal 300 to the financial company server 500 to request it to settle the corresponding affiliated store's account for the purchasing price, and then receives a result of settlement from the financial company server 500.

This settlement process can be performed through an online account transfer or credit card settlement, and the settlement related techniques are well known to those skilled in the art and a detailed description thereof will thus be omitted.

The refund request information receiver 191 is adapted to receive refund request information containing a returned amount of a corresponding one of the sub-total free-call times and the affiliated store identification information from the specific affiliated store terminal 300.

In the case where some of the free-call certificates purchased from the free-call certificate management server 100 remain after being distributed to customers, each affiliated store can request a refund of the remaining free-call certificates online/offline. For the online refund request, the refund request information with the returned amount of the sub-total free-call time transmitted from the specific affiliated store terminal 300 is received by the refund request information receiver 191.

The refund processor 192 is adapted to, if the authentication processor 130 searches the sale information stored in the free-call certificate management database 110 for the sale information corresponding to the affiliated store identification information to determine whether the corresponding sale information is present in the stored sale information, and authenticates the corresponding affiliated store as a result of the determination, request the financial company server 500 through the settlement requester 190 to pay the corresponding affiliated store a refund corresponding to the returned free-call time amount contained in the refund request information received by the refund request information receiver 191, and update the free-call certificate management database 110 on the basis of the refund request information.

That is, in response to the refund request information with the returned sub-total free-call time amount transmitted from the specific affiliated store terminal 300 and received by the refund request information receiver 191, the refund processor 192 performs a refund process for the returned free-call time amount after authentication by the authentication processor 130. The authentication processor 130 searches the sale information stored in the free-call certificate management database 110 for the sale information corresponding to the affiliated store identification information to determine whether the corresponding sale information is present in the stored sale information, and performs the authentication process based on the determination result. If the authentication processor 130 authenticates the corresponding affiliated store as a result of the determination, the refund processor 192 requests the financial company server 500 through the settlement requester 190 to pay the corresponding affiliated store a refund corresponding to the returned free-call time amount, and updates the free-call certificate management database 110 on the basis of the refund request information.

On the other hand, it is preferable that a refund request and process between the free-call certificate management server 100 and the communication company is carried out offline, and a description thereof will be omitted.

The communication company server 200 is adapted to allocate the total free-call time to the free-call certificate management server 100 and, in response to the free-call request information from the server 100, deduct the amount of money corresponding to the individual free-call time allocated to the free-call certificate acquired by the customer from communication fees to be charged to the customer's telephone number contained in the free-call request information.

Each of the affiliated store terminals 300 is adapted to transmit free-call request information with a customer's telephone number and affiliated store identification information for authentication to the free-call certificate management server 100.

Each of the affiliated store terminals 300 is also adapted to transmit the free-call certificate purchase request information containing a corresponding one of the sub-total free-call times to the free-call certificate management server 100 and receive the free-call time allocation information corresponding to the corresponding sub-total free-call time contained in the free-call certificate purchase request information from the free-call certificate management server 100.

The customer terminal 400 is adapted to receive guide information about the free-call service from the free-call certificate management server 100 and perform a telephone call using a free-call certificate issued to a corresponding customer.

The customer terminal 400 is preferably a wireless communication terminal such as a mobile telephone, PDA or etc. In this case, the free-call certificate management server 100 may transmit the guide information about the free-call service to the wireless communication terminal in the form of a short message service (SMS) message.

The financial company server 500 is adapted to process the settlement associated with the free-call certificate purchase request information from each of the affiliated store terminals.

That is, the free-call certificate management server 100 receives the free-call certificate purchase request information transmitted from each of the affiliated store terminals 300 and transmits the picture associated with the settlement of the purchasing price corresponding to the sub-total free-call time contained in the received free-call certificate purchase request information to the corresponding affiliated store terminal 300 to display it thereon. Thereafter, the free-call certificate management server 100 transmits the settlement information inputted from the corresponding affiliated store terminal 300 to the financial company server 500 to request it to settle the corresponding affiliated store's account for the purchasing price. In response to the settlement request, the financial company server 500 settles the corresponding affiliated store's account for the purchasing price and transmits the settlement result to the free-call certificate management server 100.

The settlement process by the financial company server 500 can be performed through an online account transfer or credit card settlement, and the settlement related techniques are well known to those skilled in the art and a detailed description thereof will thus be omitted.

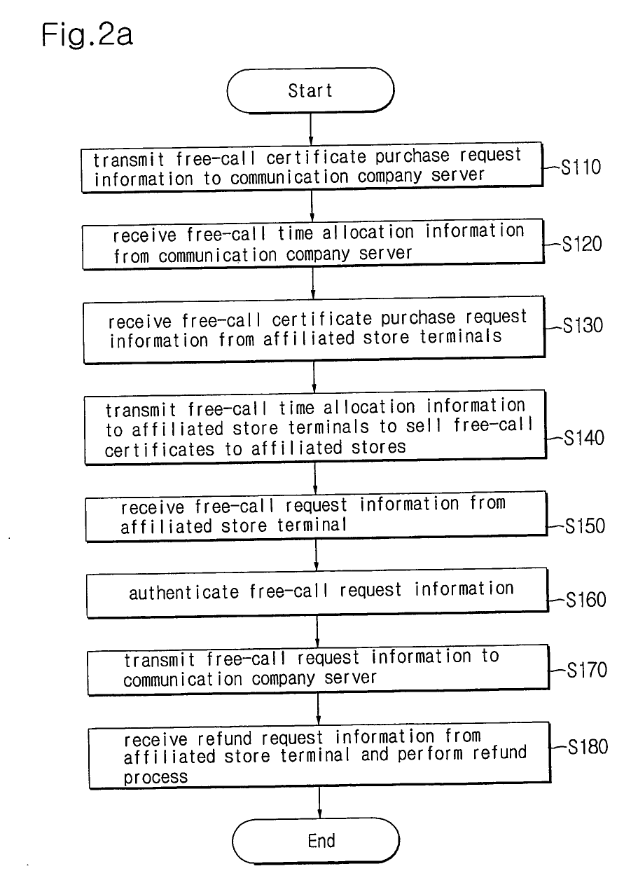

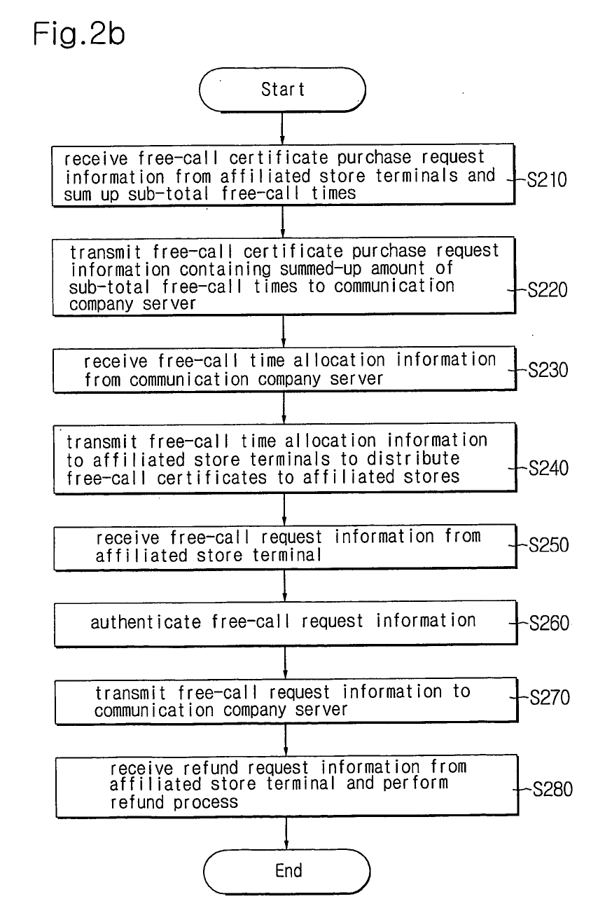

The operation of the free-call certificate service system with the above-stated configuration according to the first embodiment of the present invention will hereinafter be described in detail with reference to FIGS. 2a and 2b.

FIG. 2a is a flow chart illustrating the operation of the free-call certificate service system of FIG. 1 in the case where free-call certificates are sold in the resale scheme.

First, at step S110, the free-call certificate purchase request information transmitter 150 in the free-call certificate management server 100 transmits free-call certificate purchase request information containing a total free-call time to the communication company server 200.

At step S120, the free-call time allocation information receiver 160 in the free-call certificate management server 100 receives free-call time allocation information corresponding to the total free-call time contained in the free-call certificate purchase request information from the communication company server 200 and stores the received allocation information in the free-call certificate management database 110.

At step S130, the free-call certificate purchase request information receiver 170 in the free-call certificate management server 100 receives free-call certificate purchase request information containing sub-total free-call times from the affiliated store terminals 300, and the settlement requestor 190 in the free-call certificate management server 100 requests the financial company server 500 to settle the corresponding affiliated stores' accounts for free-call certificate purchasing prices corresponding respectively to the sub-total free-call times contained in the free-call certificate purchase request information received by the free-call certificate purchase request information receiver 170, and then receives results of settlement from the financial company server 500.

At step S140, the free-call time allocation information transmitter 180 in the free-call certificate management server 100 transmits free-call time allocation information corresponding respectively to the sub-total free-call times contained in the free-call certificate purchase request information received by the free-call certificate purchase request information receiver 170 respectively to the affiliated store terminals 300 to sell free-call certificates with individual free-call times within the ranges of the sub-total free-call times to the corresponding affiliated stores, and then stores information regarding the sales of the sold free-call certificates in the free-call certificate management database 110.

At step S150, the free-call request information receiver 120 in the free-call certificate management server 100 receives, from a specific one of the affiliated store terminals 300, free-call request information containing a telephone number of a customer acquiring a free-call certificate and affiliated store identification information.

At step S160, the authentication processor 130 in the free-call certificate management server 100 searches the sale information stored in the free-call certificate management database 110 for sale information corresponding to the affiliated store identification information to determine whether the corresponding sale information is present in the stored sale information, and performs an authentication process based on the determination result.

At step S170, the free-call request information transmitter 140 in the free-call certificate management server 100 transmits the free-call request information authenticated by the authentication processor 130 to the communication company server 200 so that the server 200 can deduct the amount of money corresponding to an individual free-call time allocated to the free-call certificate acquired by the customer from communication fees to be charged to the customer's telephone number contained in the free-call request information.

At step S180, the refund request information receiver 191 in the free-call certificate management server 100 receives, refund request information containing a returned amount of a corresponding one of the sub-total free-call times and the affiliated store identification information from the specific affiliated store terminal 300. If the authentication processor 130 searches the sale information stored in the free-call certificate management database 110 for the sale information corresponding to the affiliated store identification information to determine whether the corresponding sale information is present in the stored sale information, and authenticates the corresponding affiliated store as a result of the determination, the refund processor 192 in the free-call certificate management server 100 requests the financial company server 500 through the settlement requestor 190 to pay the corresponding affiliated store a refund corresponding to the returned free-call time amount contained in the refund request information received by the refund request information receiver 191, and updates the free-call certificate management database 110 on the basis of the refund request information.

FIG. 2b is a flow chart illustrating the operation of the free-call certificate service system of FIG. 1 in the case where free-call certificates are sold in the cooperative purchase scheme.

First, at step S210, the free-call certificate purchase request information receiver 170 in the free-call certificate management server 100 receives respective free-call certificate purchase request information containing sub-total free-call times from the affiliated store terminals 300 and sums up the sub-total free-call times, and the settlement requestor 190 in the free-call certificate management server 100 requests the financial company server 500 to settle the corresponding affiliated stores' accounts for free-call certificate purchasing prices corresponding respectively to the sub-total free-call times contained in the free-call certificate purchase request information from the affiliated store terminals 300, and then receives results of settlement from the financial company server 500. At step S220, the free-call certificate purchase request information transmitter 150 in the free-call certificate management server 100 transmits free-call certificate purchase request information containing a total free-call time, which is the summed-up amount of the sub-total free-call times, to the communication company server 200.

At step S230, the free-call time allocation information receiver 160 in the free-call certificate management server 100 receives free-call time allocation information corresponding to the total free-call time contained in the free-call certificate purchase request information from the communication company server 200.

At step S240, the free-call time allocation information transmitter 180 in the free-call certificate management server 100 transmits free-call time allocation information corresponding respectively to the sub-total free-call times contained in the free-call certificate purchase request information received by the free-call certificate purchase request information receiver 170 respectively to the affiliated store terminals 300 to sell free-call certificates with individual free-call times within the ranges of the sub-total free-call times to the corresponding affiliated stores, and then stores information regarding the sales of the free-call certificates sold to the respective affiliated stores in the free-call certificate management database 110.

At step S250, the free-call request information receiver 120 in the free-call certificate management server 100 receives, from a specific one of the affiliated store terminals 300, free-call request information containing a telephone number of a customer acquiring a free-call certificate and affiliated store identification information.

At step S260, the authentication processor 130 in the free-call certificate management server 100 searches the sale information stored in the free-call certificate management database 110 for sale information corresponding to the affiliated store identification information to determine whether the corresponding sale information is present in the stored sale information, and performs an authentication process based on the determination result.

At step S270, the free-call request information transmitter 140 in the free-call certificate management server 100 transmits the free-call request information authenticated by the authentication processor 130 to the communication company server 200 so that the server 200 can deduct the amount of money corresponding to an individual free-call time allocated to the free-call certificate acquired by the customer from communication fees to be charged to the customer's telephone number contained in the free-call request information.

At step S280, the refund request information receiver 191 in the free-call certificate management server 100 receives refund request information containing a returned amount of a corresponding one of the sub-total free-call times and the affiliated store identification information from the specific affiliated store terminal 300. If the authentication processor 130 searches the sale information stored in the free-call certificate management database 110 for the sale information corresponding to the affiliated store identification information to determine whether the corresponding sale information is present in the stored sale information, and authenticates the corresponding affiliated store as a result of the determination, the refund processor 192 in the free-call certificate management server 100 requests the financial company server 500 through the settlement requester 190 to pay the corresponding affiliated store a refund corresponding to the returned free-call time amount contained in the refund request information received by the refund request information receiver 191, and updates the free-call certificate management database 110 on the basis of the refund request information.

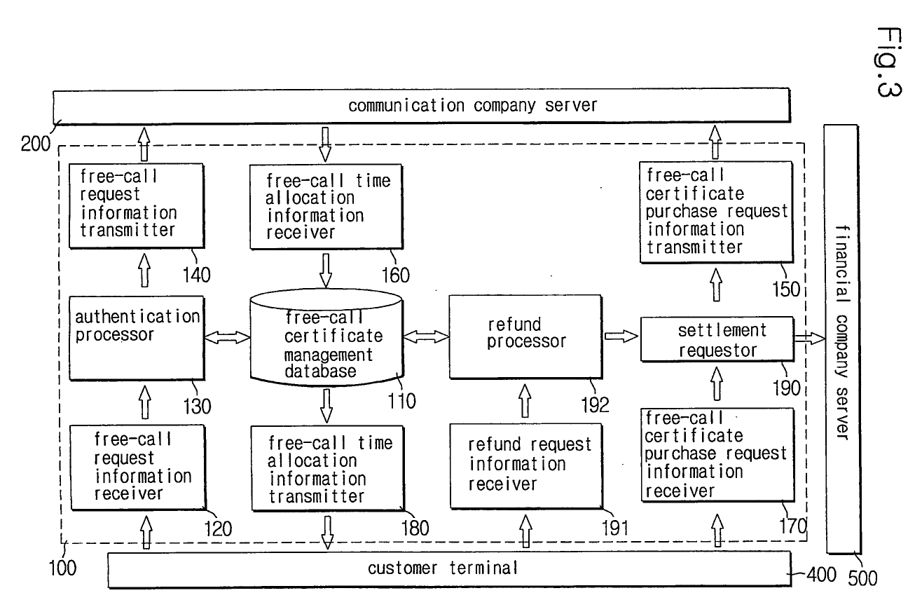

FIG. 3 is a block diagram showing the configuration of a free-call certificate service system according to a second embodiment of the present invention.

In the second embodiment, the free-call certificate service system is adapted to provide free-call certificates to customers directly without using affiliated stores, in a different manner from the first embodiment. Free-call certificates can be provided to the customers in two schemes, one being a resale scheme wherein a free-call certificate management server purchases free-call certificates from communication companies and sells the purchased free-call certificates directly to the customers, and the other being a cooperative purchase scheme wherein the free-call certificate management server collects and sums up the demands for free-call certificates from the customers, makes a cooperative purchase for the summed-up number of free-call certificates from the communication companies and distributes the purchased free-call certificates to the customers.

A free-call certificate service provider can provide free-call certificates to customers as rewards for their product purchases or service use, or free of charge to entice the customers for the purpose of gaining future profits therefrom. Therefore, the free-call certificates can be provided online/offline to customers with or without compensation for many purposes throughout society.

The free-call certificates can be provided in various forms such as offline coupons containing the provider's advertisement, or electronic barcodes in digital data format. That is, the free-call certificates can be provided in various ways irrespective of form as long as they have information regarding free calls.

With reference to FIG. 3, the free-call certificate service system according to the second embodiment of the present invention comprises a free-call certificate management server 100, at least one communication company server 200, one or more customer terminals 400 and at least one financial company server 500.

The free-call certificate management server 100 acts to purchase free-call certificates from communication companies, sell the purchased free-call certificates to customers, store information regarding the sales of the purchased certificates and perform a CRM process based on the stored free-call certificate sale information.

The free-call certificate management server 100 is adapted to sell free-call certificates in the following two schemes.

The first scheme is a resale scheme wherein the free-call certificate management server purchases free-call certificates from the communication companies in large quantities and sells the purchased free-call certificates to customers with or without compensation.

The second scheme is a cooperative purchase scheme wherein the free-call certificate management server collects and sums up the demands for free-call certificates from customers, makes a cooperative purchase for the summed-up number of free-call certificates from the communication companies and distributes the purchased free-call certificates to the customers.

It should be noted that the above-mentioned free-call certificate sale schemes are just matters of sale procedure and have no effect on the configuration of the free-call certificate service system according to the present embodiment.

In detail, the free-call certificate management server 100 includes a free-call certificate management database 110, a free-call request information receiver 120, an authentication processor 130, a free-call request information transmitter 140, a free-call certificate purchase request information transmitter 150, a free-call time allocation information receiver 160, a free-call certificate purchase request information receiver 170, a free-call time allocation information transmitter 180, a settlement requester 190, a refund request information receiver 191, and a refund processor 192.

The free-call certificate management database 110 is adapted to store information regarding the sales of free-call certificates sold to one or more customers. The free-call certificate sale information contains sub-total free-call times allocated respectively to the customers within the range of a total free-call time allocated from at least one communication company.

One or more wired/wireless communication companies provide telephone services to customers, and the customers select the communication companies according to their tastes and receive the telephone services from the selected communication companies.

Hence, the free-call certificate management server 100 preferably performs an integrated management process of requesting the purchase of free-call certificates from one or more communication companies, receiving free-call times allocated respectively from the communication companies and storing information regarding the sales of free-call certificates sold to respective customers, which information contains sub-total free-call times allocated respectively to the customers within the range of a total amount of the free-call times allocated from the communication companies. This integrated management process is well known to those skilled in the art and a detailed description thereof will thus be omitted.

The free-call certificate sale information further contains respective identification information of the customers, the amount or number of free-call certificates purchased from each communication company by each of the customers, the amount or number of the purchased free-call certificates in stock, etc. The CRM process can be performed on the basis of the free-call certificate sale information.

The free-call request information receiver 120 is adapted to receive free-call request information containing a telephone number of a specific one of the customers acquiring a free-call certificate from a specific one of the customer terminals 400.

The free-call certificate management server 100 distributes free-call certificates to customers with or without compensation, and any one of the customers acquiring at least one of the free-call certificates inputs free-call request information containing his/her telephone number using the corresponding customer terminal 400 to transmit it to the free-call certificate management server 100.

The authentication processor 130 is adapted to search the sale information stored in the free-call certificate management database 110 for sale information corresponding to the specific customer's telephone number to determine whether the corresponding sale information is present in the stored sale information, and perform an authentication process based on the determination result.

The sale information stored in the free-call certificate management database 110 contains respective identification information of the customers containing the customers' telephone numbers, the amount or number of free-call certificates purchased from each communication company by each of the customers, the amount or number of the purchased free-call certificates in stock, etc. The authentication processor 130 searches the stored sale information for the sale information corresponding to the specific customer's telephone number transmitted from the specific customer terminal 400, received by the free-call request information receiver 120, to determine whether the corresponding sale information is present in the stored sale information, and performs the authentication process based on the determination result. In the authentication process, the authentication processor 130 outputs authentication information if the corresponding sale information is present in the stored sale information, and authentication failure information if the corresponding sale information is not present in the stored sale information. This technique for searching the database and performing the authentication process based on the search result is well known to those skilled in the art and a detailed description thereof will thus be omitted.

The free-call request information transmitter 140 is adapted to transmit the free-call request information authenticated by the authentication processor 130 to the communication company server 200 so that the server 200 can deduct the amount of money corresponding to an individual free-call time allocated to the free-call certificate acquired by the specific customer from communication fees to be charged to the specific customer's telephone number contained in the free-call request information.

That is, the free-call request information transmitter 140 transmits the free-call request information containing the specific customer's telephone number, authenticated by the authentication processor 130, to the communication company server 200. A billing server of the communication company server 200 receives the free-call request information transmitted from the free-call request information transmitter 140, deducts the amount of money corresponding to the individual free-call time allocated to the free-call certificate acquired by the specific customer from communication fees of the next term to be charged to the specific customer's telephone number contained in the free-call request information, and issues the resulting communication fee bill to the customer. As a result, the customer can enjoy a free-call service using the free-call certificate as a reward for his/her online/offline product purchase or service use. This has the effect of reducing the customer's burden of communication cost, which leads to a more tangible reward.

The free-call certificate purchase request information transmitter 150 is adapted to transmit free-call certificate purchase request information containing a total free-call time to the communication company server 200.

Namely, the free-call certificate management server 100 requests the purchase of free-call certificates with individual free-call times within the range of a total free-call time from at least one communication company online/offline in the resale scheme or cooperative purchase scheme. The offline purchase request can be made based on a contract, and the online purchase request can be made through the fact that the free-call certificate purchase request information transmitter 150 transmits the free-call certificate purchase request information containing the total free-call time to the communication company server 200.

The free-call time allocation information receiver 160 is adapted to receive, from the communication company server 200, free-call time allocation information corresponding to the total free-call time contained in the free-call certificate purchase request information.

In other words, if the free-call certificate purchase request information transmitter 150 transmits the free-call certificate purchase request information containing the total free-call time to the communication company server 200, then the server 200 receives the transmitted free-call certificate purchase request information, allocates the total free-call time contained therein to the free-call certificate management server 100 and transmits the resulting allocation information thereto. Then, the free-call time allocation information receiver 160 receives the free-call time allocation information transmitted from the communication company server 200 and stores it in the free-call certificate management database 110.

The free-call certificate purchase request information receiver 170 is adapted to receive free-call certificate purchase request information containing a sub-total free-call time from each of the customer terminals 400.

Each customer requests the purchase of free-call certificates with individual free-call times within the range of a sub-total free-call time corresponding to his/her demand from the free-call certificate management server 100 online/offline. The online purchase request can be made through the fact that the corresponding customer terminal 400 transmits the free-call certificate purchase request information containing the sub-total free-call time to the free-call certificate purchase request information receiver 170.

The free-call time allocation information transmitter 180 is adapted to transmit free-call time allocation information corresponding respectively to the sub-total free-call times contained in the free-call certificate purchase request information received by the free-call certificate purchase request information receiver 170 respectively to the customer terminals 400.

If the free-call certificate management server 100 receives the free-call certificate purchase request information containing the sub-total free-call time transmitted from each of the customer terminals 400, then it allocates the corresponding customer the sub-total free-call time within the range of the total free-call time stored in the free-call certificate management database 110 and transmits the resulting allocation information to the corresponding customer terminal 400 to sell free-call certificates with individual free-call times within the range of the sub-total free-call time to the corresponding customer. The free-call certificate management server 100 then stores information regarding the sales of the sold free-call certificates in the free-call certificate management database 110.

The settlement requester 190 is adapted to transmit settlement request information to the financial company server 500 to request it to settle the customers' accounts for the prices for purchases of the free-call certificates, respectively, and then receive results of settlement from the financial company server 500.

In other words, upon receiving the free-call certificate purchase request information transmitted from each of the customer terminals 400, the free-call certificate management server 100 transmits a picture associated with settlement of a purchasing price corresponding to the sub-total free-call time contained in the received free-call certificate purchase request information to the corresponding customer terminal 400 to display it thereon. Thereafter, the settlement requester 190 transmits settlement information inputted from the customer terminal 400 to the financial company server 500 to request it to settle the corresponding customer's account for the purchasing price, and then receives a result of settlement from the financial company server 500.

This settlement process can be performed through an online account transfer or credit card settlement, and the settlement related techniques are well known to those skilled in the art and a detailed description thereof will thus be omitted.

The refund request information receiver 191 is adapted to receive refund request information containing the specific customer's telephone number and a returned amount of a corresponding one of the sub-total free-call times from the specific customer terminal 400.

If desired, each customer can request a refund of some or all of the free-call certificates purchased from the free-call certificate management server 100 online/offline. For the online refund request, the refund request information with the returned amount of the sub-total free-call time transmitted from the specific customer terminal 400 is received by the refund request information receiver 191.

The refund processor 192 is adapted to, if the authentication processor 130 searches the sale information stored in the free-call certificate management database 110 for the sale information corresponding to the specific customer's telephone number to determine whether the corresponding sale information is present in the stored sale information, and authenticates the specific customer as a result of the determination, request the financial company server 500 through the settlement requester 190 to pay the specific customer a refund corresponding to the returned free-call time amount contained in the refund request information received by the refund request information receiver 191, and update the free-call certificate management database 110 on the basis of the refund request information.

That is, in response to the refund request information with the returned sub-total free-call time amount transmitted from the specific customer terminal 400 and received by the refund request information receiver 191, the refund processor 192 performs a refund process for the returned free-call time amount after authentication by the authentication processor 130. The authentication processor 130 searches the sale information stored in the free-call certificate management database 110 for the sale information corresponding to the specific customer's telephone number to determine whether the corresponding sale information is present in the stored sale information, and performs the authentication process based on the determination result. If the authentication processor 130 authenticates the specific customer as a result of the determination, the refund processor 192 requests the financial company server 500 through the settlement requestor 190 to pay the specific customer a refund corresponding to the returned free-call time amount, and updates the free-call certificate management database 110 on the basis of the refund request information.

On the other hand, it is preferable that a refund request and process between the free-call certificate management server 100 and the communication company is carried out offline, and a description thereof will be omitted.

The communication company server 200 is adapted to allocate the total free-call time to the free-call certificate management server 100 and, in response to the free-call request information from the server 100, deduct the amount of money corresponding to the individual free-call time allocated to the free-call certificate acquired by the specific customer from communication fees to be charged to the specific customer's telephone number contained in the free-call request information.

Each of the customer terminals 400 is adapted to receive guide information about the free-call service from the free-call certificate management server 100 and perform a telephone call using a free-call certificate issued to the corresponding customer.

Each of the customer terminals 400 is preferably a wireless communication terminal such as a mobile telephone, PDA or etc. In this case, the free-call certificate management server 100 may transmit the guide information about the free-call service to the wireless communication terminal in the form of an SMS message.

The financial company server 500 is adapted to process the settlement associated with the free-call certificate purchase request information from each of the customer terminals 400.

That is, the free-call certificate management server 100 receives the free-call certificate purchase request information transmitted from each of the customer terminals 400 and transmits the picture associated with the settlement of the purchasing price corresponding to the sub-total free-call time contained in the received free-call certificate purchase request information to the corresponding customer terminal 400 to display it thereon. Thereafter, the free-call certificate management server 100 transmits the settlement information inputted from the customer terminal 400 to the financial company server 500 to request it to settle the corresponding customer's account for the purchasing price. In response to the settlement request, the financial company server 500 settles the corresponding customer's account for the purchasing price and transmits the settlement result to the free-call certificate management server 100.

The settlement process by the financial company server 500 can be performed through an online account transfer or credit card settlement, and the settlement related techniques are well known to those skilled in the art and a detailed description thereof will thus be omitted.

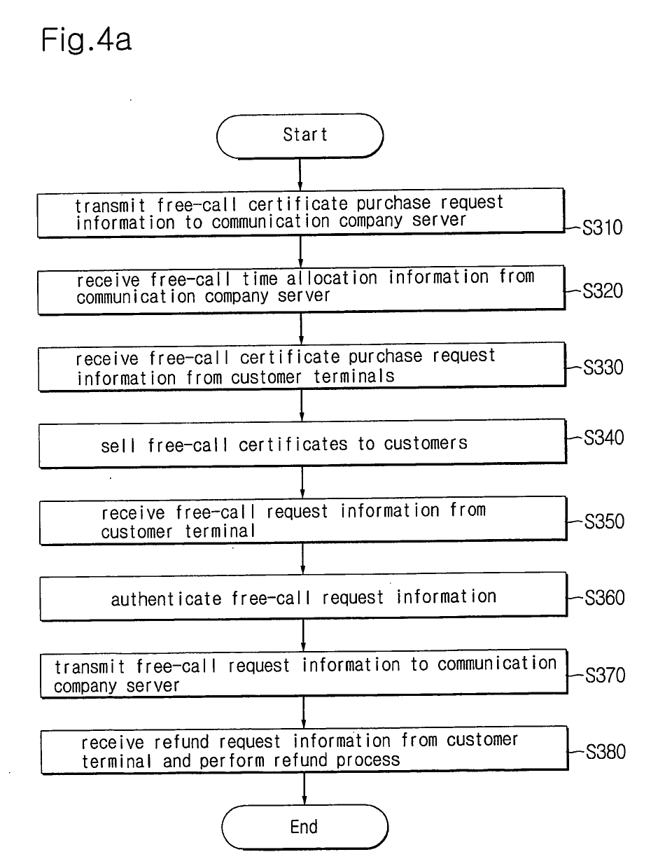

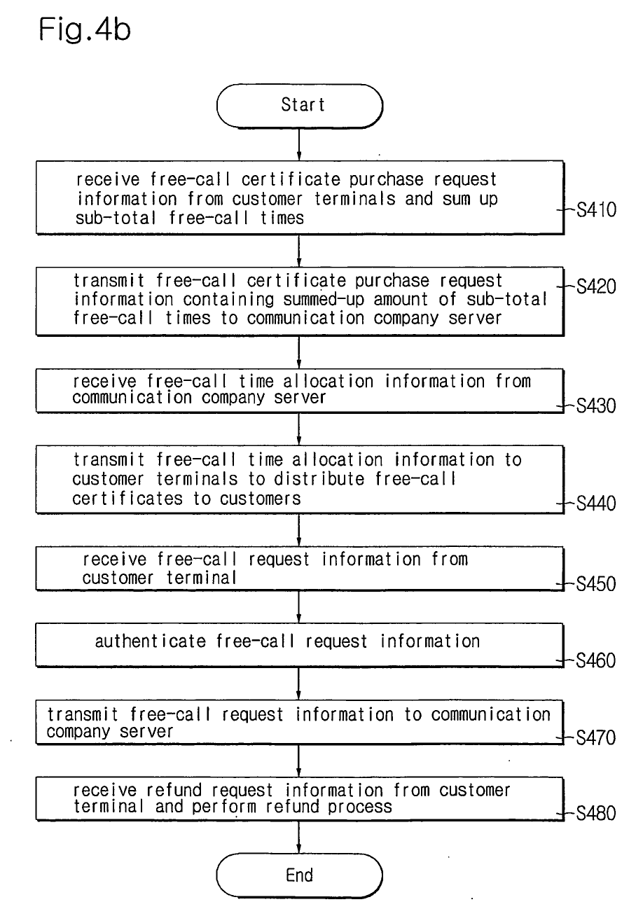

The operation of the free-call certificate service system with the above-stated configuration according to the second embodiment of the present invention will hereinafter be described in detail with reference to FIGS. 4a and 4b.

FIG. 4a is a flow chart illustrating the operation of the free-call certificate service system of FIG. 3 in the case where free-call certificates are sold in the resale scheme.

First, at step S310, the free-call certificate purchase request information transmitter 150 in the free-call certificate management server 100 transmits free-call certificate purchase request information containing a total free-call time to the communication company server 200.

At step S320, the free-call time allocation information receiver 160 in the free-call certificate management server 100 receives free-call time allocation information corresponding to the total free-call time contained in the free-call certificate purchase request information from the communication company server 200 and stores the received allocation information in the free-call certificate management database 110.

At step S330, the free-call certificate purchase request information receiver 170 in the free-call certificate management server 100 receives free-call certificate purchase request information containing sub-total free-call times from the customer terminals 400, and the settlement requestor 190 in the free-call certificate management server 100 requests the financial company server 500 to settle the corresponding customers' accounts for free-call certificate purchasing prices corresponding respectively to the sub-total free-call times contained in the free-call certificate purchase request information received by the free-call certificate purchase request information receiver 170, and then receives results of settlement from the financial company server 500.

At step S340, the free-call time allocation information transmitter 180 in the free-call certificate management server 100 transmits free-call time allocation information corresponding respectively to the sub-total free-call times contained in the free-call certificate purchase request information received by the free-call certificate purchase request information receiver 170 respectively to the customer terminals 400 to sell free-call certificates with individual free-call times within the ranges of the sub-total free-call times to the corresponding customers, and then stores information regarding the sales of the sold free-call certificates in the free-call certificate management database 110.

At step S350, the free-call request information receiver 120 in the free-call certificate management server 100 receives free-call request information containing a telephone number of a specific one of the customers acquiring a free-call certificate from a specific one of the customer terminals 400.

At step S360, the authentication processor 130 in the free-call certificate management server 100 searches the sale information stored in the free-call certificate management database 110 for sale information corresponding to the specific customer's telephone number to determine whether the corresponding sale information is present in the stored sale information, and performs an authentication process based on the determination result.

At step S370, the free-call request information transmitter 140 in the free-call certificate management server 100 transmits the free-call request information authenticated by the authentication processor 130 to the communication company server 200 so that the server 200 can deduct the amount of money corresponding to an individual free-call time allocated to the free-call certificate acquired by the specific customer from communication fees to be charged to the specific customer's telephone number contained in the free-call request information.

At step S380, the refund request information receiver 191 in the free-call certificate management server 100 receives refund request information containing the specific customer's telephone number and a returned amount of a corresponding one of the sub-total free-call times from the specific customer terminal 400. If the authentication processor 130 searches the sale information stored in the free-call certificate management database 110 for the sale information corresponding to the specific customer's telephone number to determine whether the corresponding sale information is present in the stored sale information, and authenticates the specific customer as a result of the determination, the refund processor 192 in the free-call certificate management server 100 requests the financial company server 500 through the settlement requester 190 to pay the specific customer a refund corresponding to the returned free-call time amount contained in the refund request information received by the refund request information receiver 191, and updates the free-call certificate management database 110 on the basis of the refund request information.

FIG. 4b is a flow chart illustrating the operation of the free-call certificate service system of FIG. 3 in the case where free-call certificates are sold in the cooperative purchase scheme.

First, at step S410, the free-call certificate purchase request information receiver 170 in the free-call certificate management server 100 receives respective free-call certificate purchase request information containing sub-total free-call times from the customer terminals 400 and sums up the sub-total free-call times, and the settlement requestor 190 in the free-call certificate management server 100 requests the financial company server 500 to settle the corresponding customers' accounts for free-call certificate purchasing prices corresponding respectively to the sub-total free-call times contained in the free-call certificate purchase request information from the customer terminals 400, and then receives results of settlement from the financial company server 500.

At step S420, the free-call certificate purchase request information transmitter 150 in the free-call certificate management server 100 transmits free-call certificate purchase request information containing a total free-call time, which is the summed-up amount of the sub-total free-call times, to the communication company server 200.

At step S430, the free-call time allocation information receiver 160 in the free-call certificate management server 100 receives free-call time allocation information corresponding to the total free-call time contained in the free-call certificate purchase request information from the communication company server 200.

At step S440, the free-call time allocation information transmitter 180 in the free-call certificate management server 100 transmits free-call time allocation information corresponding respectively to the sub-total free-call times contained in the free-call certificate purchase request information received by the free-call certificate purchase request information receiver 170 respectively to the customer terminals 400 to sell free-call certificates with individual free-call times within the ranges of the sub-total free-call times to the corresponding customers, and then stores information regarding the sales of the free-call certificates sold to the respective customers in the free-call certificate management database 110.

At step S450, the free-call request information receiver 120 in the free-call certificate management server 100 receives free-call request information containing a telephone number of a specific one of the customers acquiring a free-call certificate from a specific one of the customer terminals 400.

At step S460, the authentication processor 130 in the free-call certificate management server 100 searches the sale information stored in the free-call certificate management database 110 for sale information corresponding to the specific customer's telephone number to determine whether the corresponding sale information is present in the stored sale information, and performs an authentication process based on the determination result.

At step S470, the free-call request information transmitter 140 in the free-call certificate management server 100 transmits the free-call request information authenticated by the authentication processor 130 to the communication company server 200 so that the server 200 can deduct the amount of money corresponding to an individual free-call time allocated to the free-call certificate acquired by the specific customer from communication fees to be charged to the specific customer's telephone number contained in the free-call request information.

At step S480, the refund request information receiver 191 in the free-call certificate management server 100 receives refund request information containing the specific customer's telephone number and a returned amount of a corresponding one of the sub-total free-call times from the specific customer terminal 400. If the authentication processor 130 searches the sale information stored in the free-call certificate management database 110 for the sale information corresponding to the specific customer's telephone number to determine whether the corresponding sale information is present in the stored sale information, and authenticates the specific customer as a result of the determination, the refund processor 192 in the free-call certificate management server 100 requests the financial company server 500 through the settlement requestor 190 to pay the specific customer a refund corresponding to the returned free-call time amount contained in the refund request information received by the refund request information receiver 191, and updates the free-call certificate management database 110 on the basis of the refund request information.

In this manner, the free-call certificate service system according to the present invention can accomplish the above-presented object.

### INDUSTRIAL APPLICABILITY

As apparent from the above description, the present invention provides a free-call certificate service system which is capable of returning a portion of the price for online/offline product purchase or fee for online/offline service use to a customer in the form of a free-call certificate, which allows the customer to conduct a telephone conversation free of charge up to a predetermined amount of, money or for a predetermined period of time, as a reward for the product purchase or service use, so as to reduce the customer's burden of communication cost and thus enable the customer to enjoy a more tangible reward service. An affiliated store can provide free-call certificates to customers instead of discount benefits or thank-you gifts, thereby obtaining the effect of performing public relations, sales promotion and customer enticement. A communication company can fixedly sell free-call certificates in large quantities, so as to increase sales and secure stable earnings. A free-call certificate service provider can purchase the free-call certificates from the communication company in large quantities at low price and resell them at higher price, so as to obtain resale profits.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A free-call certificate service system comprising a free-call certificate management server including:
a free-call certificate management database for storing information regarding sales of free-call certificates sold to one or more affiliated stores, said free-call certificate sale information containing sub-total free-call times allocated respectively to the affiliated stores within the range of a total free-call time allocated from at least one communication company;
a free-call request information receiver for receiving free-call request information containing a telephone number of a customer acquiring a specific one of the free-call certificates and affiliated store identification information from a specific one of one or more affiliated store terminals held respectively by said affiliated stores;
an authentication processor for searching the sale information stored in said free-call certificate management database for sale information corresponding to said affiliated store identification information to determine whether the corresponding sale information is present in the stored sale information, and performing an authentication process based on the determination result; and
a free-call request information transmitter for transmitting said free-call request information authenticated by said authentication processor to a communication company server managed by said communication company so that the communication company server can deduct the amount of money corresponding to an individual free-call time allocated to said specific free-call certificate acquired by said customer from communication fees to be charged to said customer's telephone number contained in said free-call request information.

2. The free-call certificate service system as set forth in claim 1, wherein said free-call certificate management server further includes:
a free-call certificate purchase request information transmitter for transmitting free-call certificate purchase request information containing said total free-call time to said communication company server; and
a free-call time allocation information receiver for receiving, from said communication company server, free-call time allocation information corresponding to said total free-call time contained in said free-call certificate purchase request information.

3. The free-call certificate service system as set forth in claim 2, wherein said free-call certificate management server further includes:
a free-call certificate purchase request information receiver for receiving free-call certificate purchase request information containing each of said sub-total free-call times from each of said affiliated store terminals; and
a free-call time allocation information transmitter for transmitting free-call time allocation information corresponding respectively to said sub-total free-call times contained in said free-call certificate purchase request information received by said free-call certificate purchase request information receiver respectively to said affiliated store terminals.

4. The free-call certificate service system as set forth in claim 3, wherein said free-call certificate management server further includes a settlement requestor for transmitting settlement request information to at least one financial company server to request it to settle said affiliated stores' accounts for prices for purchases of said free-call certificates, respectively, and then receiving results of settlement from said financial company server.

5. The free-call certificate service system as set forth in claim 4, wherein said free-call certificate management server further includes:
a refund request information receiver for receiving refund request information containing a returned amount of a corresponding one of said sub-total free-call times and said affiliated store identification information from said specific affiliated store terminal; and
a refund processor for, if said authentication processor searches the sale information stored in said free-call certificate management database for the sale information corresponding to said affiliated store identification information to determine whether the corresponding sale information is present in the stored sale information, and authenticates a specific one of said affiliated stores holding said specific affiliated store terminal as a result of the determination, requesting said financial company server through said settlement requestor to pay said specific affiliated store a refund corresponding to the returned free-call time amount contained in said refund request information received by said refund request information receiver, and updating said free-call certificate management database on the basis of said refund request information.

6. The free-call certificate service system as set forth in claim 1, further comprising said communication company server adapted for allocating said total free-call time to said free-call certificate management server and, in response to said free-call request information from said free-call certificate management server, deducting the amount of money corresponding to said individual free-call time allocated to said specific free-call certificate acquired by said customer from the communication fees to be charged to said customer's telephone number contained in said free-call request information.

7. The free-call certificate service system as set forth in claim 6, further comprising said one or more affiliated store terminals, each adapted for transmitting free-call request information containing a customer's telephone number and affiliated store identification information for authentication to said free-call certificate management server.

8. The free-call certificate service system as set forth in claim 7, wherein each of said affiliated store terminals is further adapted to transmit said free-call certificate purchase request information containing a corresponding one of said sub-total free-call times to said free-call certificate management server and receive said free-call time allocation information corresponding to the corresponding sub-total free-call time contained in said free call certificate purchase request information from the free-call certificate management server.

9. The free-call certificate service system as set forth in claim 7o, further comprising said at least one financial company server adapted for processing the settlement associated with said free-call certificate purchase request information from each of said affiliated store terminals.

10. The free-call certificate service system as set forth in claim 9, further comprising at least one customer terminal for receiving guide information about a free-call service from said tree-call certificate management server and performing a telephone call using a free-call certificate issued to a corresponding customer.

11. The free-call certificate service system as set forth in claim 10, wherein said customer terminal is a wireless communication terminal, said wireless communication terminal being any one of a mobile telephone or personal digital assistant (PDA).

12. The free-call certificate service system as set forth in claim 11, wherein said free-call certificate management server is adapted to transmit said guide information about said free-call service to said wireless communication terminal in the form of a short message service (SMS) message.

13-22. (canceled)

23. The free-call certificate service system as set forth in claim 8, further comprising said at least one financial company server adapted for processing the settlement associated with said free-call certificate purchase request information from each of said affiliated store terminals.
